(19) United States
(12) Patent Application Publication
(10) Pub. No.: US 2021/0073860 A1
(43) Pub. Date: Mar. 11, 2021

(54) METHODS, SYSTEMS, APPARATUSES, AND DEVICES FOR FACILITATING PRESENTATION OF PROMOTIONAL CONTENT TO A USER OF A RIDE-SHARING SERVICE

(71) Applicant: Thomas SmithAssaly, Ottawa (CA)

(72) Inventor: Thomas SmithAssaly, Ottawa (CA)

(21) Appl. No.: 17/017,197

(22) Filed: Sep. 10, 2020

Related U.S. Application Data
(60) Provisional application No. 62/898,090, filed on Sep. 10, 2019.

(51) Int. Cl. G06Q 30/02; G06Q 50/30; G06Q 10/10

(52) U.S. Cl. CPC G06Q 30/0266; G06Q 50/30; G06Q 30/0267; G01C 21/3476; G06Q 30/0273; G06Q 10/10; G06Q 30/0277; G06Q 30/0269

(57) ABSTRACT

Disclosed is a system for facilitating presentation of promotional content to a user of a ride-sharing service. Further, the system may include a communication device configured for receiving an event data associated with a ride-sharing session, receiving a promotional content from a promotional content provider device, and transmitting the promotional content to a vehicular presentation device comprised in a vehicle. Further, the system may include a processing device configured for analyzing the event data, identifying the promotional content based on the analyzing, and generating a tracking data based on the transmitting of the promotional content to the vehicular presentation device. Further, the processing device may be configured for generating a revenue data based on the tracking data. Further, the system may include a storage device configured for storing each of the tracking data and the revenue data in association with a driver account identifier.

The current application claims a priority to the U.S. Provisional Patent application serial number 62/898,090 filed on Sep. 10, 2019.

### TECHNICAL FIELD

Generally, the present disclosure relates to the field of data processing. More specifically, the present disclosure relates to methods, systems, apparatuses, and devices for facilitating presentation of promotional content to a user of a ride-sharing service.

### BACKGROUND

Due to the high cost of vehicle ownership, many owners have turned to ride sharing services to use their vehicles to produce revenue by driving their vehicles as a cab, also many vehicles such as, buses, trains and airlines owned by companies are experiencing stress on their revenues due to the pandemic and need to generate other sources of revenue. Also, many customers have turned to ride-sharing as an economical approach to their transportation needs. Further, the ride sharing services are in need of drivers to fulfill the demand, while meeting customer service on a timely basis. Also, the drivers and companies that own mass transportation vehicles are experiencing cost increases in operating their vehicle, therefore, they need additional revenue sources to cover rising costs without increasing rider fees.

Therefore, there is a need for improved methods, systems, apparatuses, and devices for facilitating presentation of promotional content to a user of a ride-sharing service that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a system for facilitating presentation of promotional content to a user of a ride-sharing service is disclosed. Further, the system may include a communication device configured for receiving an event data associated with a ride-sharing session. Further, the ride-sharing session may be associated with each of a user account and a driver account. Further, the user account may be associated with the user. Further, the driver account may be associated with a vehicle operated by a driver during the ride-sharing session. Further, the company account for mass transportation vehicles may be associated with a vehicle operated by the company. Further, the communication device may be configured for receiving a promotional content from a promotional content provider device. Further, the communication device may be configured for transmitting the promotional content to a vehicular presentation device comprised in the vehicle. Further, the vehicular presentation device may be configured for presenting the promotional content. Further, the system may include a processing device communicatively coupled to the communication device. Further, the processing device may be configured for analyzing the event data. Further, the processing device may be configured for identifying the promotional content based on the analyzing. Further, the processing device may be configured for generating a tracking data based on the transmitting of the promotional content to the vehicular presentation device. Further, the tracking data may include a promotional content indicator associated with the promotional content and a driver account identifier associated with the driver account. Further, the processing device may be configured for generating a revenue data based on the tracking data. Further, the system may include a storage device communicatively coupled to the processing device. Further, the storage device may be configured for storing each of the tracking data and the revenue data in association with the driver account identifier.

According to some embodiments, a method for facilitating presentation of promotional content to a user of a ride-sharing service is disclosed. The method may include receiving, using a communication device, an event data associated with a ride-sharing session. Further, the ride-sharing session may be associated with each of a user account and a driver account. Further, the user account may be associated with the user. Further, the driver account may be associated with a vehicle operated by a driver during the ride-sharing session. Further, the company account for mass transportation vehicles may be associated with a vehicle operated by the company. Further, the method may include analyzing, using a processing device, the event data. Further, the method may include identifying, using the processing device, a promotional content based on the analyzing. Further, the method may include receiving, using the communication device, the promotional content from a promotional content provider device. Further, the method may include transmitting, using the communication device, the promotional content to a vehicular presentation device comprised in the vehicle. Further, the vehicular presentation device may be configured for presenting the promotional content. Further, the method may include generating, using the processing device, a tracking data based on the transmitting of the promotional content to the vehicular presentation device. Further, the tracking data may include a promotional content indicator associated with the promotional content and a driver account identifier associated with the driver account. Further, the method may include generating, using the processing device, a revenue data based on the tracking data. Further, the method may include storing, using a storage device each of the tracking data, and the revenue data in association with the driver account identifier.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating presentation of promotional content to a user of a ride-sharing service, in accordance with some embodiments.

FIG. 3 is a block diagram of the system for facilitating presentation of promotional content to a user of a ride-sharing service, in accordance with further embodiments.

FIG. 4 is a block diagram of the system for facilitating presentation of promotional content to a user of a ride-sharing service, in accordance with further embodiments.

FIG. 5 is a block diagram of the system for facilitating presentation of promotional content to a user of a ride-sharing service, in accordance with further embodiments.

FIG. 6 is a block diagram of the system for facilitating presentation of promotional content to a user of a ride-sharing service, in accordance with further embodiments.

FIG. 7 is a flowchart of a method for facilitating presentation of promotional content to a user of a ride-sharing service, in accordance with some embodiments.

FIG. 8 is a flowchart of a method to share user information, in accordance with some embodiments.

FIG. 9 is a flowchart of a method for obtaining an analytical report, in accordance with some embodiments.

FIG. 10 is a flowchart of a method for obtaining ride information, in accordance with some embodiments.

FIG. 11 is a flowchart of a method for providing promotional content based on a location and a motion of the vehicle, in accordance with some embodiments.

FIG. 12 is a flowchart of a method for providing promotional content based on a location and a motion of the vehicle, in accordance with some embodiments.

FIG. 13 is a schematic of a login user interface of a VARA tablet, in accordance with some embodiments.

FIG. 14 is a schematic of a home page user interface of the VARA tablet, in accordance with some embodiments.

FIG. 15 is a schematic of a welcome user interface of the VARA tablet, in accordance with some embodiments.

FIG. 16 is a schematic of an advertisement user interface of the VARA tablet, in accordance with some embodiments.

FIG. 17 is a schematic of a streaming advertisement user interface of the VARA tablet, in accordance with some embodiments.

FIG. 18 is a schematic of a farewell user interface of the VARA tablet, in accordance with some embodiments.

FIG. 19 is a schematic of an authentication user interface of a database cloud admin, in accordance with some embodiments.

FIG. 20 is a schematic of a user information user interface of the database cloud admin, in accordance with some embodiments.

FIG. 21 is a schematic of a ride capture user interface of the database cloud admin, in accordance with some embodiments.

FIG. 22 is a schematic of ads captured user interface of the database cloud admin, in accordance with some embodiments.

FIG. 23 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of presentation of promotional content to a user of a ride-sharing service, embodiments of the present disclosure are not limited to use only in this context.

Overview:

The present disclosure describes a system of advertising for rideshare vehicles and mass transportation vehicles operated by companies such as Greyhound, Amtrack, Delta Airlines, etc. Further, the present disclosure describes a vehicle advertising and revenue assistance system.

Further, the disclosed system may allow vehicle owners to use space on the back of the headrests of their vehicles for advertising and revenue production. The disclosed system may be referred to as VARA.

Further, the disclosed systems and methods produce revenue for vehicle owners by using vehicle headrests to install a video tablet (VARA tablet) for advertising. The video tablet will be shipped to the driver or to companies such as Greyhound, Amtrack, Delta Airlines, etc., that operate mass transportation vehicles who can install the VARA system as an aftermarket system at a very low cost without affecting the operation or warranty of the vehicle. Alternatively, the video table can be installed at the time of the purchase of the passenger vehicle which can be financed by the owner at a small incremental increase to the car payment. The latter may be popular with car dealers since it may assist in selling more passenger vehicles, due to the device producing a new revenue stream for the new owner to assist in making the car payments. For example, the VARA tablet may be an Android™ compatible tablet.

Further, many parts of the disclosed system (VARA system) are already manufactured for other purposes, but they are repurposed for the specific purpose of the disclosed system. For example, the video systems presently installed as an option in many passenger vehicles allow parents to play DVDs for their children to watch while being driven around. These video systems can be repurposed to run advertising streamed by a VARA application, without changing the original purpose of the option, just as the vehicle can be repurposed for ride share from its primary intent of personal transportation. For example, the VARA application may be coded for Apple or Android™.

Further, the disclosed system may produce revenue for the vehicle owners by using a vehicle video system for advertising. Local and National advertisers are streamed through the VARA application to the VARA system. The application may work in conjunction with Uber™ or Lyft™, taxi company or other 3rd party passenger vehicle booking and tracking application. As soon as a driver activates the pickup of the rider, advertising is streamed to the Uber™ or Lyft™, taxi company or other 3rd party passenger vehicle application as well as the video system in the vehicle. Further, for every minute the vehicle is carrying a Rider the advertisements are displayed on the VARA system so the owner is paid a fee for each VARA installed.

Further, the disclosed system functions through an application interface that piggybacks with the drivers' rideshare application. The owners of the VARA system will be given a key code to log into their accounts once the system has been installed in their vehicle. Once logged in, the user will register their VARA with its serial number (or key code) which will then be tracked for usage by the rideshare application. All payments will be made to the driver's bank account registered on their account. This additional revenue will amount to more Revenue than the driver could earn from merely driving for Uber™ or Lyft™ taxi company and/or other 3rd party passenger vehicle and will help attract much needed drivers to Uber™ or Lyft™ taxi company or other 3rd party passenger vehicle.

Further, the VARA system may include a VARA Platform tablet. The specification of the VARA Platform tablet may include one or more of the following features:
Color: Gold/Black/Silver/Grey/Green (Optional)
Plug: UK/US/EU/AU (Optional)
Operating system: Android 10.0
CPU: MTK6793 ten Core
GPU: Mali-400
RAM:10GB
ROM:512GB (The system will occupy a part of storage space and memory)
Screen: 10.1 Inch IPS screen
Screen specifications: Capacitance Touch
Screen: Capacitive Screen, Multi-touch
Screen Resolution: 1920*108 0 (Use different Software test may a little different, if any question, please contact us first)
Camera sensor type: CMOS
Front Camera: 5 million pixels
Network: Wi-Fi IEEE 802.11b/g/n
Bluetooth: 4.1
Media: MIC support/FM support/GPS support/G sensor support
Battery: Lithium battery 3.8V 4500 mAh. Playing video around 4 to 5.5 hours after full charge. (Depending on usage and sound level)
Power adapter: 5V/2A
Flash: Support hardware decoding
FLASH 11 Audio format: support MP3, WMA, APE, FLAC, OGG, WAV, and so on
Video format: support 3gp, AVI, MP4, MKV, F4V and so on
Image format: support JPEG, PNG, BMP, GIF, and so on
Audio Port: 1×3.5 mm stereo headphone jack
OTG function: support Built-in applications: VARA Application, Browser, Email, Video Player, Calculator, Calendar, Clock, File Manager, Camera, Music, Google Apps
Language: English, Chinese, Simplified Chinese, Japanese, Korean, German, French, Italian, Russian, One hundred national languages, etc.

Further, the VARA Platform tablet may one or more of the following features:
1. 10.1 inch HD amazing screen makes each picture vivid and the details clearer.
2. 10 GB big memory and 512 GB storage space can ensure smooth operation. You can quickly switch to other applications in seconds without carton.

3. The 5-million-pixel front camera with auto focus camera can make your photograph crystal clear.

4. With the broad cavity design, high-pitched mid-tone, and precise bass, the tablet has 3D surround sound, which brings a better audio fest.
5. The thickness of the fuselage is only 6.9 mm and it is made of smooth material, which makes it lighter to suspend from the front seat headrests.
6. Support Bluetooth 4.1. It is widely compatible with Bluetooth phones and Bluetooth headsets.
7. Built-in 8800 mAh high-capacity lithium ion polymer battery can ensure long service life and long endurance.
8. Update to the three global GPS which has real time connection and the higher accuracy of location. (Note that it needs to be used in open areas outdoors.)
9. Support Android 10.0 system. It also supports all kinds of software and development downloads.
10. Expanded Storage and Connection. The Unlocked Tablet built in micro USB slot, you can use OTG cable connect to other devices, such as a keyboard, mouse, speaker, etc. You can also use Bluetooth to connect your other devices. The tablets are good for kids, lovers, parents, and elders. It is a good gift and easy to use.
11. VARA Platform: Supports the VARA Application, and live streaming of ads and promotional material.

It may be noted:
1. Due to the different display and lighting effects, the actual color of the project may be slightly different from the color shown on the picture.
2. If the product cannot be turned on, then the user may use the charger to charge for more than 15 minutes.
3. If a user uses software to test the tablet, it may cause misjudgment due to software, such as screen size. Then the user may measure the size of the screen directly with a ruler.
4. The user should not let the tablet fall to the ground or hit it with a hard object; especially on the display.
5. The user should not put the tablet in a damp or overheated place. The user should not let the liquid into the body. If there is liquid on the body surface, the user may immediately wipe clean and dry before using it.

Further, a package may include one or more of 1×Tablet, 1×Power Adaptor (UK/US/EU/AU) (Optional), 1×User Manual, 1×Box, 1×OTG Cable, and 1×Charging Cable.

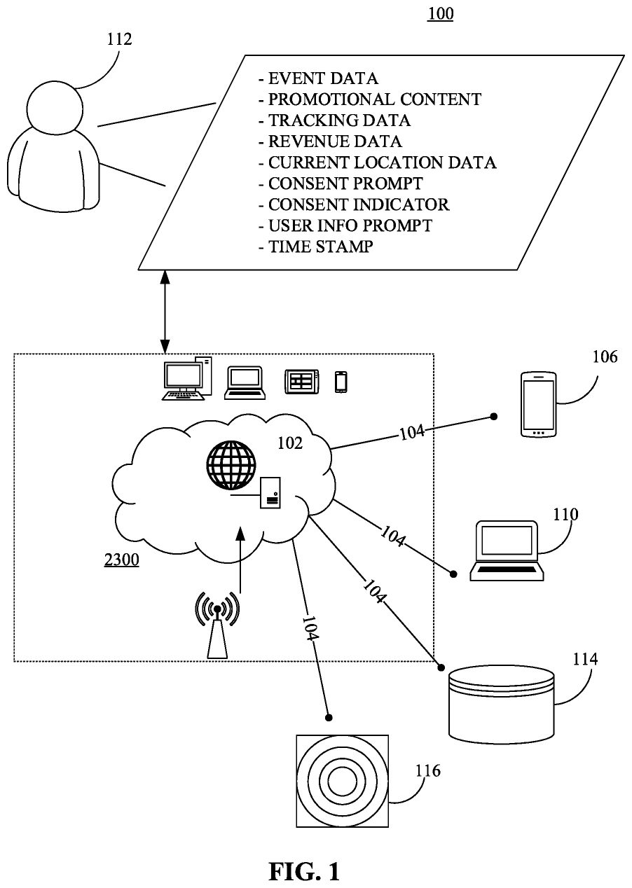

FIG. 1 is an illustration of an online platform 100 consistent with various embodiments of the present disclosure. By way of non-limiting example, the online platform 100 to facilitate presentation of promotional content to a user of a ride-sharing service may be hosted on a centralized server 102, such as, for example, a cloud computing service. In some embodiments, the ride-sharing service may include a fare based transportation service. Further, in some embodiments, the ride-sharing service may include a car pooling service. Accordingly, the user may include a plurality of users. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2300.

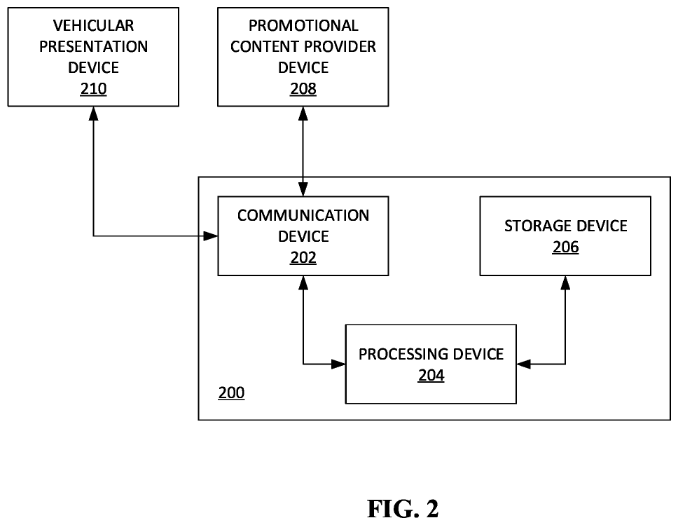

FIG. 2 is a block diagram of a system 200 for facilitating presentation of promotional content to a user of a ride-sharing service, in accordance with some embodiments. In an instance, the ride-sharing service may include a fare based transportation service. Further, in some embodiments, the ride-sharing service may include a car pooling service. Accordingly, the user may include a plurality of users.

Further, the system 200 may include a communication device 202. Further, the system 200 may include a processing device 204 communicatively coupled to the communication device 202. Further, the system 200 may include a storage device 206 communicatively coupled to the processing device 204.

Further, the communication device 202 may be configured for receiving an event data associated with a ride-sharing session. Further, the ride-sharing session may be associated with each of a user account and a driver account. Further, the user account may be associated with the user. Further, the driver account may be associated with a vehicle operated by a driver during the ride-sharing session. In some embodiments, the vehicle may include a passenger vehicle. Further, in some embodiments, the vehicle may be operated by a driver situated in the vehicle. Alternatively, the vehicle may be remotely operated by a driver. Further, in some embodiments, the vehicle may be manually driven.

Alternatively, and/or additionally, in some embodiments, the vehicle may be an autonomous vehicle or a self-driving vehicle. Examples of the vehicle may include, but are not limited to, a land based vehicle such as an automobile, a water based vehicle such as a motor boat and/or an air based vehicle such as a drone taxi.

In some embodiments, the event data may include at least one of a start ride-sharing event, a stop ride-sharing event, an add-stop event and an in-progress ride sharing event.

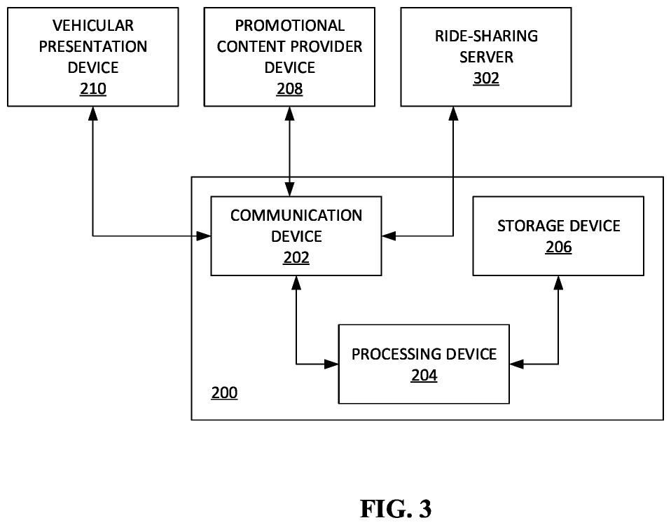

In some embodiments, the event data may be received from a Ride-Sharing Server 302 (such as the centralized server 102) as shown in FIG. 3.

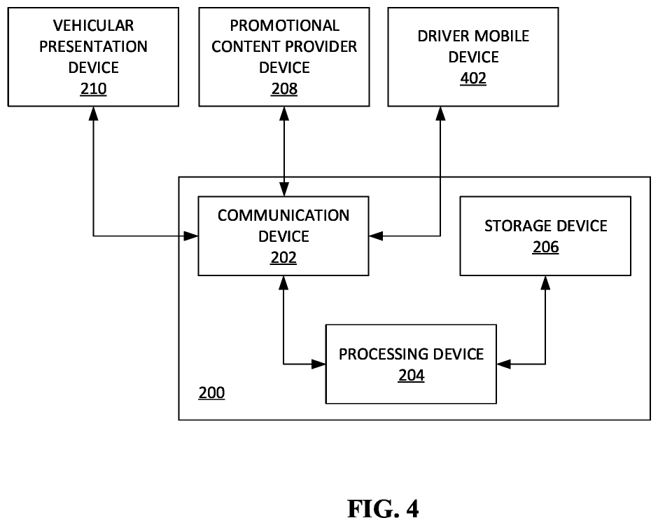

In some embodiments, the event data may be received from a driver mobile device 402 as shown in FIG. 4. Further, the driver mobile device 402 may be configured for capturing the event data from a ride sharing application executing on the driver mobile device 402 and transmitting the event data.

Further, the communication device 202 may be configured for receiving a promotional content from a promotional content provider device 208.

Further, the communication device 202 may be configured for transmitting the promotional content to a vehicular presentation device 210 comprised in the vehicle. Further, the vehicular presentation device 210 may be configured for presenting the promotional content.

Further, the processing device 204 may be configured for analyzing the event data and identifying the promotional content based on the analyzing.

Further, the processing device 204 may be configured for generating a tracking data based on the transmitting of the promotional content to the vehicular presentation device 210. Further, the tracking data may include a promotional content indicator associated with the promotional content and a driver account identifier associated with the driver account.

Further, the processing device 204 may be configured for generating a revenue data based on the tracking data.

Further, the storage device 206 may be configured for storing each of the tracking data and the revenue data in association with the driver account identifier.

In some embodiments, the communication device 202 may be further configured for receiving a current location data from at least one of the driver mobile device 402, an on-board navigation system included in the vehicle and the vehicular presentation device 210. Further, the identifying of the promotional content may be based on the current location data.

In some embodiments, the promotional content may include a plurality of promotional content items and a plurality of time periods associated with the plurality of promotional content items. Further, the tracking data may include a number indicator associated with the plurality of promotional content items and a plurality of time indicators associated with the plurality of time periods.

According to some embodiments, the processing device 204 may be configured for generating a time stamp associated with the transmitting of the promotional content. Further, the tracking data may include the time stamp associated with the promotional content. Further, the processing device 204 may be configured for analyzing the tracking data. the processing device 204 may be configured for generating an analytical report based on the analyzing of the tracking data. Further, the communication device 202 may be configured for transmitting the analytical report and the revenue data to the driver mobile device 402.

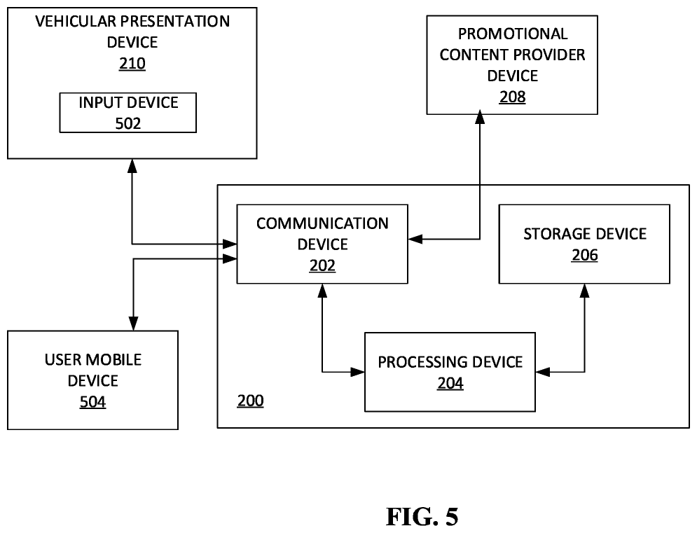

FIG. 5 is a block diagram of the system 200 for facilitating presentation of promotional content to a user of a ride-sharing service, in accordance with further embodiments. Accordingly, the communication device 202 may be further configured for transmitting a consent prompt to the vehicular presentation device 210 based on the stop ride-sharing event. Further, the vehicular presentation device 210 may be configured for presenting the consent prompt to the user.

Further, the communication device 202 may be configured for receiving a consent indicator from the vehicular presentation device 210. Further, the vehicular presentation device 210 may include an input device 502 configured for receiving the consent indicator from the user.

Further, the communication device 202 may be configured for transmitting a user information prompt to the vehicular presentation device 210. Further, the vehicular presentation device 210 may be configured for presenting the user information prompt to the user.

Further, the communication device 202 may be configured for receiving user information associated with the user from the vehicular presentation device 210. Further, the input device 502 may be configured for receiving the user information from the user.

Further, the communication device 202 may be configured for transmitting the promotional content to a user mobile device 504 associated with the user based on the user information. Further, the promotional content may include a promotional offer.

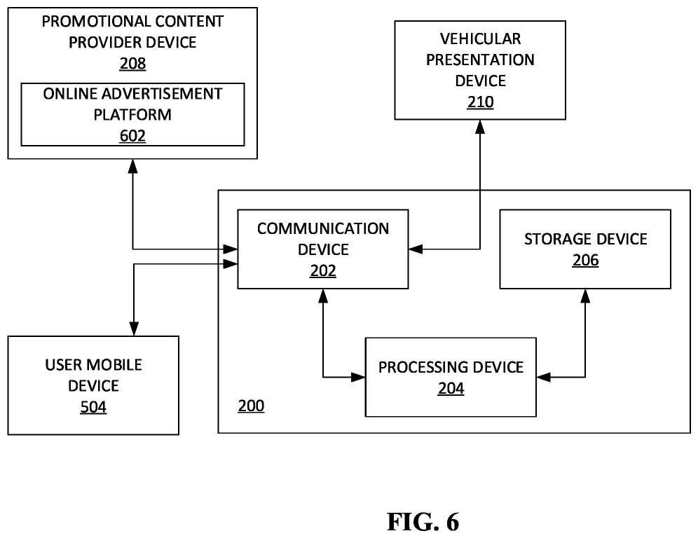

FIG. 6 is a block diagram of the system 200 for facilitating presentation of promotional content to a user of a ride-sharing service, in accordance with further embodiments. As shown, the promotional content provider device 208 may include an online advertisement platform 602. Further, the communication device 202 may be configured for receiving ride information from a ride-sharing server associated with the ride-sharing session. In some embodiments, the ride information may include one or more of an origin location indication, a destination location indication, a route indication and one or more intermediate stop locations indication. Further, in some embodiments, the ride information may include user information associated with the user. For instance, the user information may include a profile information of the user such as, but not limited to, a demographic characteristic, a user interest, a user-behavior indicator and so on. Alternatively, in some embodiments, the communication device 202 may be configured for receiving the ride information from the driver mobile device. Furthermore, in some embodiments, one or more of the driver mobile device and the vehicular presentation device may be configured to communicate with a user device of the user over a short range communication channel such as, but not limited to, Bluetooth. Accordingly, in some embodiments, the user information may be received from the user device and subsequently transmitted to the communication device 202. Further, the communication device 202 may be configured for transmitting at least one keyword to the online advertisement platform 602. Further, the receiving of the promotional content is in response to the transmitting of the at least one keyword. Further, the processing device 204 may be configured for generating the at least one keyword based on the ride information.

According to some embodiments, the communication device 202 may be further configured for receiving at least one of a plurality of location data and a motion data from at least one of the driver mobile device 402 and the vehicular presentation device 210.

Further, the communication device 202 may be configured for determining a motion state of the vehicle based on at least one of the plurality of location data and the motion data. Further, the identifying of the promotional content may be based on the motion state.

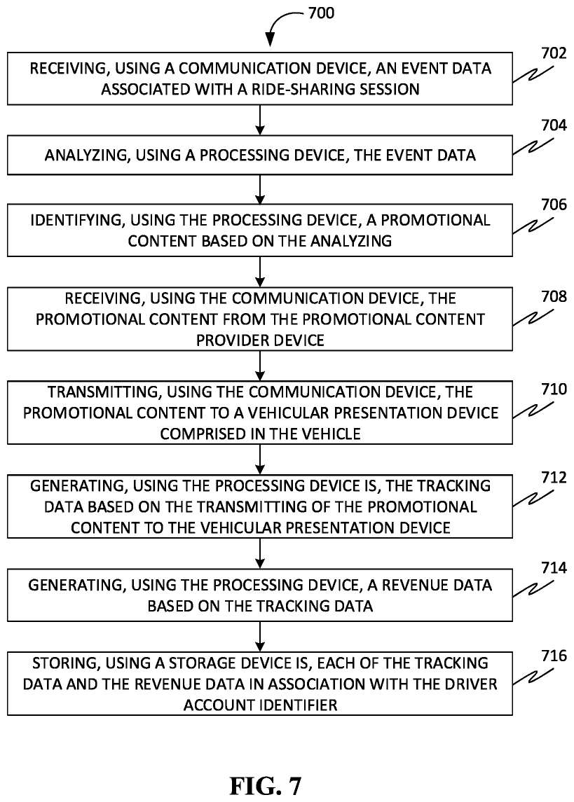

FIG. 7 is a flowchart of a method 700 for facilitating presentation of promotional content to a user of a ride-sharing service, in accordance with some embodiments.

Further, at 702, the method 700 may include receiving, using a communication device (such as the communication device 202), an event data associated with a ride-sharing session. Further, the ride-sharing session may be associated with each of a user account and a driver account. Further, the user account may be associated with the user. Further, the driver account may be associated with a vehicle operated by a driver during the ride-sharing session.

In some embodiments, the event data may be received, using the communication device, from a ride-sharing server (such as the ride-sharing server 302).

In some embodiments, the event data may be received, using the communication device, from a driver mobile device (such as the driver mobile device 402). Further, the driver mobile device may be configured for capturing the event data from a ride sharing application executing on the driver mobile device and transmitting the event data.

In some embodiments, the event data may include at least one of a start ride-sharing event, a stop ride-sharing event, an add-stop event and an in-progress ride sharing event.

Further, at 704, the method 700 may include analyzing, using a processing device (such as the processing device 204), the event data.

Further, at 706, the method 700 may include identifying, using the processing device, a promotional content based on the analyzing.

Further, at 708, the method 700 may include receiving, using the communication device, the promotional content from a promotional content provider device (such as the promotional content provider device 208).

Further, at 710, the method 700 may include transmitting, using the communication device, the promotional content to a vehicular presentation device (such as the vehicular presentation device 210) comprised in the vehicle. Further, the vehicular presentation device may be configured for presenting the promotional content.

Further, at 712, the method 700 may include generating, using the processing device, a tracking data based on the transmitting of the promotional content to the vehicular presentation device. Further, the tracking data may include a promotional content indicator associated with the promotional content and a driver account identifier associated with the driver account.

Further, at 714, the method 700 may include generating, using the processing device, a revenue data based on the tracking data.

Further, at 716, the method 700 may include storing, using a storage device (such as the storage device 206), each of the tracking data and the revenue data in association with the driver account identifier.

According to further embodiments, the method 700 may include receiving, using a communication device, a current location data from at least one of the driver mobile device, an on-board navigation system (i.e. including a geo-location device such as a GPS receiver) included in the vehicle and the vehicular presentation device. Further, the identifying of the promotional content is based on the current location data.

In some embodiments, the promotional content may include a plurality of promotional content items and a plurality of time periods associated with the plurality of promotional content items. Further, the tracking data may include a number indicator associated with the plurality of promotional content items and a plurality of time indicators associated with the plurality of time periods.

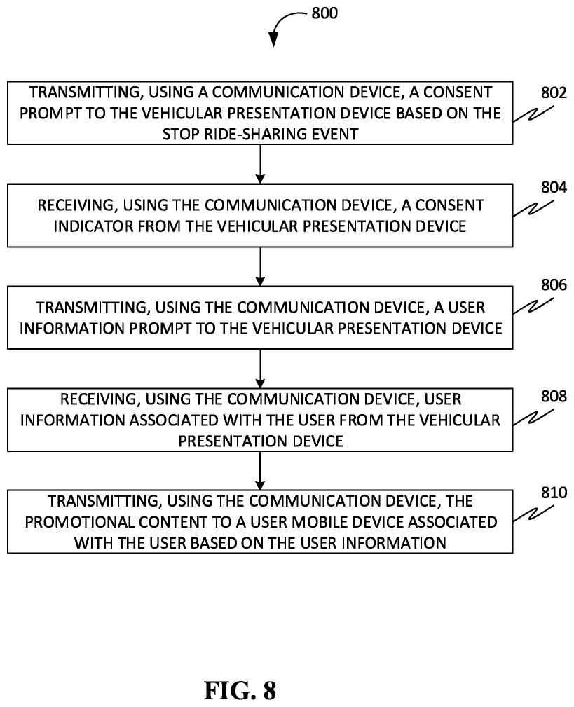

FIG. 8 is a flowchart of a method 800 to share user information, in accordance with some embodiments. At 802, the method 800 may include transmitting, using the communication device, a consent prompt to the vehicular presentation device based on the stop ride-sharing event. Further, the vehicular presentation device may be configured for presenting the consent prompt to the user.

Further, at 804, the method 800 may include receiving, using the communication device, a consent indicator from the vehicular presentation device. Further, the vehicular presentation device may include an input device configured for receiving the consent indicator from the user.

Further, at 806, the method 800 may include transmitting, using the communication device, a user information prompt to the vehicular presentation device. Further, the vehicular presentation device may be configured for presenting the user information prompt to the user.

Further, at 808, the method 800 may include receiving, using the communication device, the user information associated with the user from the vehicular presentation device. Further, the input device may be configured for receiving the user information from the user. For example, the user information may include one or more of user's name, age, address, email address, etc.

Further, at 810, the method 800 may include transmitting, using the communication device, the promotional content to a user mobile device associated with the user based on the user information. Further, the promotional content may include a promotional offer.

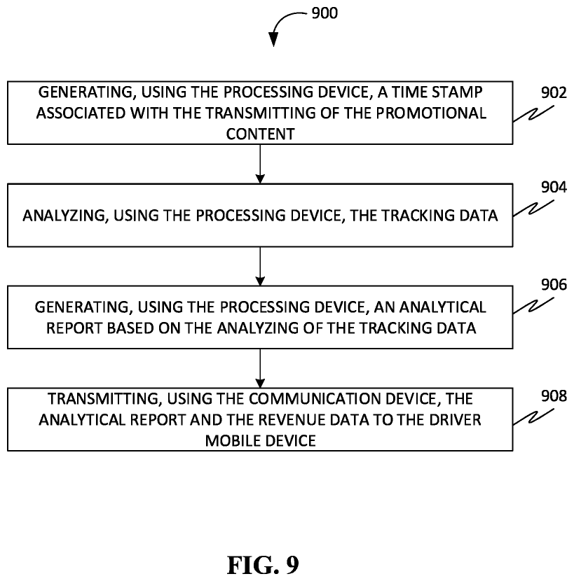

FIG. 9 is a flowchart of a method 900 for obtaining an analytical report, in accordance with some embodiments. At 902, the method 900 may include generating, using the processing device, a time stamp associated with the transmitting of the promotional content, wherein the tracking data further comprises the time stamp associated with the promotional content.

Further, at 904, the method 900 may include analyzing, using the processing device, the tracking data.

Further, at 906, the method 900 may include generating, using the processing device, an analytical report based on the analyzing of the tracking data. For example, the analytical report may include information to number of times the promotional content was displayed on the vehicular presentation device, the revenue earned by the driver, etc.

Further, at 908, the method 900 may include transmitting, using the communication device, the analytical report and the revenue data to the driver mobile device.

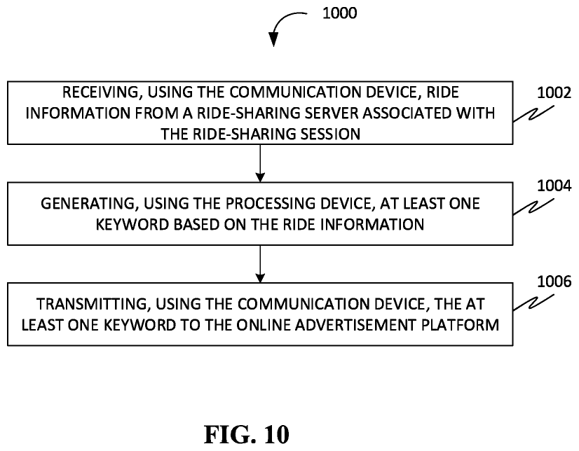

FIG. 10 is a flowchart of a method 1000 for obtaining ride information, in accordance with some embodiments. At 1002, the method 1000 may include receiving, using the communication device, ride information from a ride-sharing server associated with the ride-sharing session. For example, the ride-sharing server may be associated with a ride-sharing application provider. Further, the ride information may include information about the start location, the destination location, the locations on the way from the start location, and the destination location.

Further, at 1004, the method 1000 may include generating, using the processing device, at least one keyword based on the ride information. For example, the at least one keyword may be generated based on at least one of the start location, the destination location, the locations on the way from the start location, and the destination location.

Further, at 1006, the method 1000 may include transmitting, using the communication device, the at least one keyword to an online advertisement platform.

Further, the receiving of the promotional content may be in response to the transmitting of the at least one keyword. Further, the promotional content provider device may include the online advertisement platform.

Accordingly, the promotional content displayed on the vehicular presentation device may be based on the ride information. For example, local advertisements may be on the vehicular presentation device based on at least one of the start location, the destination location, the locations on the way from the start location, and the destination location.

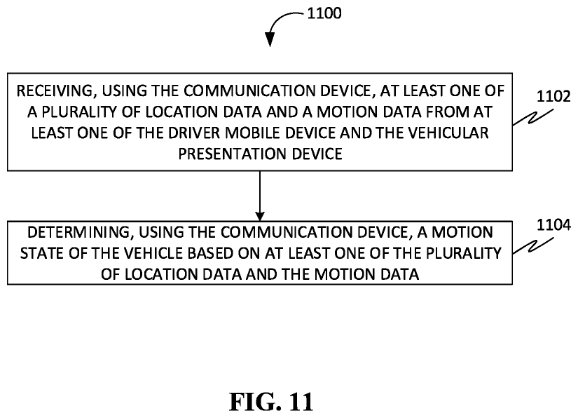

FIG. 11 is a flowchart of a method 1100 for providing promotional content based on a location and a motion of the vehicle, in accordance with some embodiments. At 1102, the method 1100 may include receiving, using the communication device, at least one of a plurality of location data and a motion data from at least one of the driver mobile device and the vehicular presentation device. For example, it may be determined when the vehicle is stuck in a traffic jam or the vehicle has stopped at a traffic signal.

Further, at 1104, the method 1100 may include determining, using the processing device, a motion state of the vehicle based on at least one of the plurality of location data and the motion data. Further, the identifying of the promotional content is based on the motion state. For example, when it is determined that the vehicle is stuck in a traffic jam or the vehicle has stopped at a traffic signal, high priority promotional content (advertisements) may be displayed as the user may focus more on the vehicular presentation device during such situations.

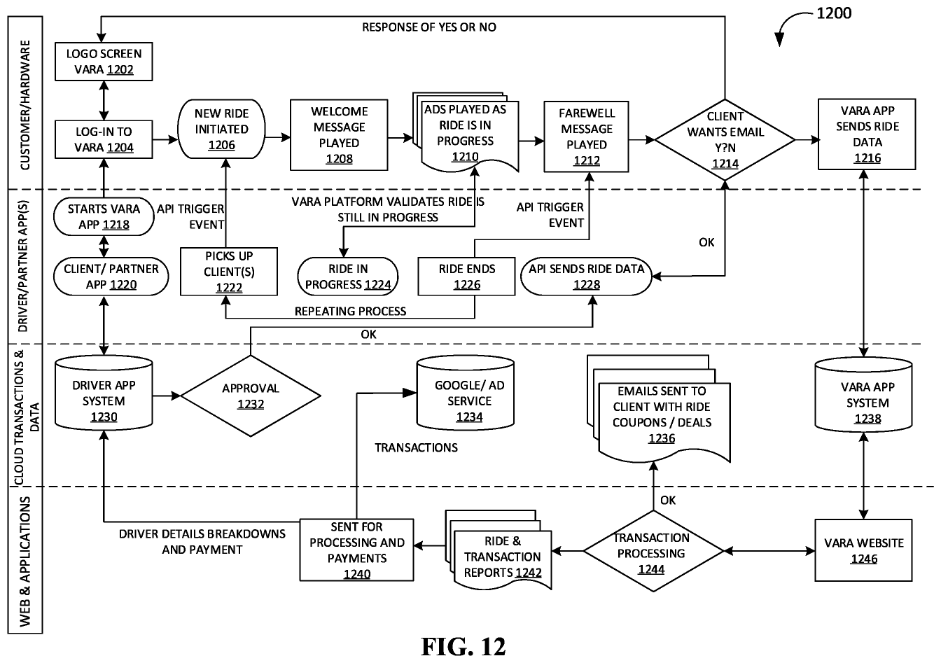

FIG. 12 is a flowchart of a method 1200 for providing promotional content based on a location and a motion of the vehicle, in accordance with some embodiments. At 1202, the method 1200 may include showing a logo screen on a VARA application associated with a customer/passenger. At 1204, the method 1200 may include logging-in to the VARA application. At 1206, the method 1200 may include initiating a new ride. At 1208, the method 1200 may include displaying a welcome message. Further, at 1210, the method 1200 may include displaying as a ride is in progress.

Further, at 1224, the method 1200 may include validating the ride in progress by the VARA platform.

At 1212, the method 1200 may include displaying a farewell message. At 1214, the method 1200 may include determining if the client wants email (Y/N). At 1216, the method 1200 may include sending ride data to the VARA application. Alternatively, at 1228, the method 1200 may include sending API ride data.

At 1218, the method 1200 may include starting the VARA application associated with a driver. At 1220, the method 1200 may include initiating client/ partner application.

Further, after step 1212, the method 1200 may include ending the ride at 1226. Further, at 1222, the method 1200 may include picking up a client(s).

Further, at 1244, the method 1200 may include transaction processing. Further, at 1236, the method 1200 may include emails sent to client with ride coupons/deals. Alternatively, at 1242, the method 1200 may include generating and sharing ride and transaction reports. At 1240, the method 1200 may include sent for processing and payments. At 1234, the method 1200 may include communicating with Google/ ad service, other add service companies or VARA's own ads regarding transactions.

Further, at 1230, the method 1200 may include a driver application system. At 1232, the method 1200 may include determining approval.

At 1238, the method 1200 may include the VARA application system obtaining the VARA application that sends ride data. At 1246, the method 1200 may include a VARA website in communication with the VARA application system.

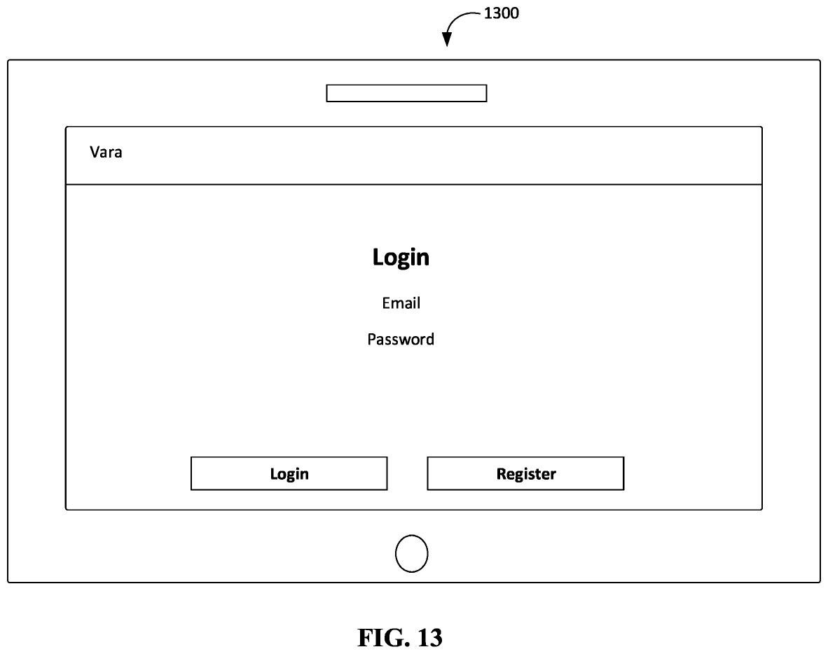

FIGS. 13-18 are schematics of various user interfaces of a VARA tablet, in accordance with exemplary embodiments.

FIG. 13 is a schematic of a login user interface 1300 of a VARA tablet, in accordance with some embodiments. The login user interface 1300 allows a user to login to an existing account on the VARA Platform system. The User Login Information is securely stored in the cloud (such as firebase or other database cloud user authentication). Further, the login user interface 1300 allows a user to sign-up for a VARA platform system account. The user information entered by the user is captured and stored in our cloud solution. This may be handled by the VARA platform cloud firebase or other database solution.

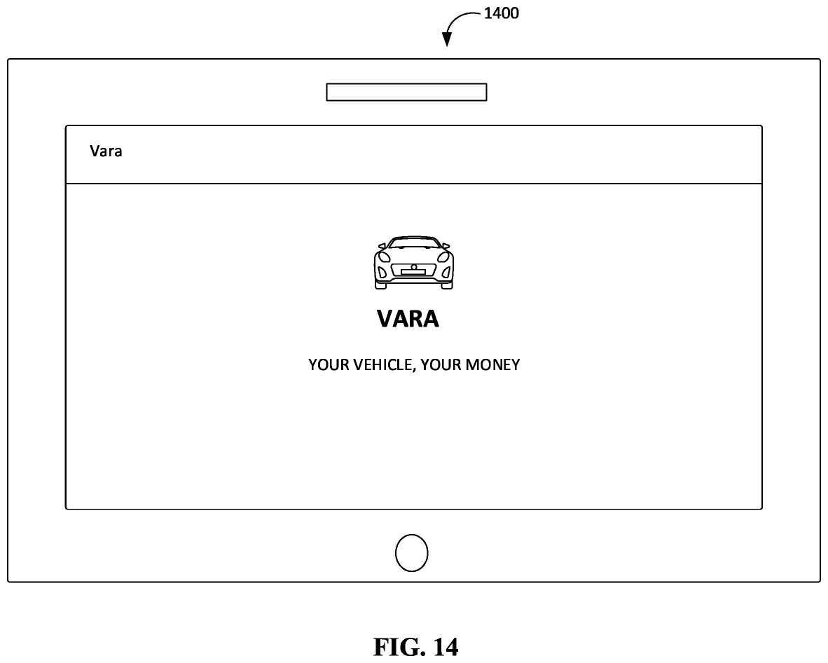

FIG. 14 is a schematic of a home page user interface 1400 of the VARA tablet, in accordance with some embodiments. The home page user interface 1400 allows the user to log-out of the platform. The user may use the ellipses in the upper right corner for a drop-down menu. The options may include user admin (to update information in “UserInfo collection) and log-out.

Further, the home page user interface 1400 may be used as the default ‘Waiting Screen’. Accordingly, upon logging in to the system, the user is brought to the home page user interface 1400. Further, the home page user interface 1400 may be shown between rides being provided to clients. Accordingly, the home page user interface 1400 may not capture or do anything. Further, the time spent on the home page user interface 1400 may be captured as a stat (Up/On time) as Per driver/per day entry.

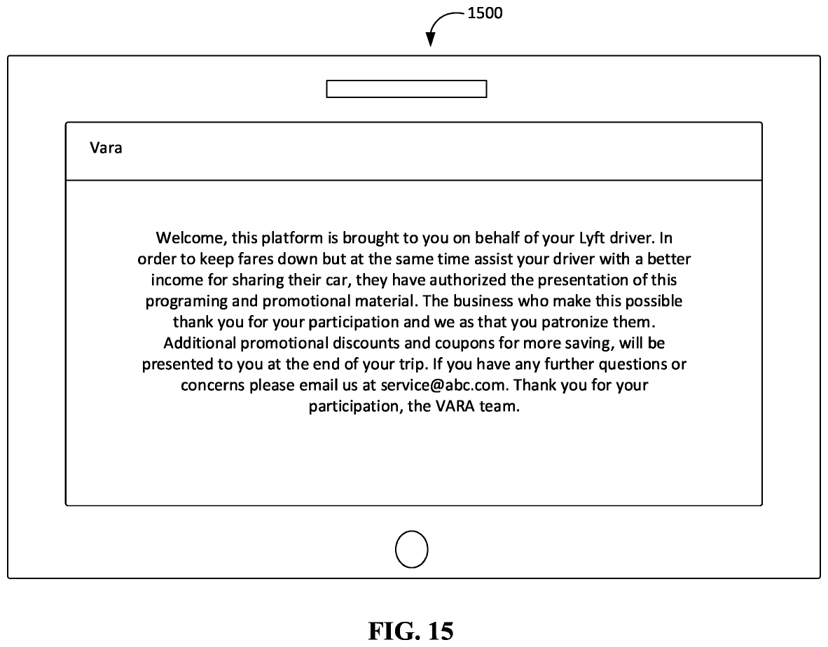

FIG. 15 is a schematic of a welcome user interface 1500 of the VARA tablet, in accordance with some embodiments. The welcome user interface 1500 may show up when a ride is initiated. The triggers for ride initiation may be as follows:
1. VARA platform user must be logged in to their account.
2. User must be connected through an authorized service partner.
3. Service Partner application will send a trigger event to the VARA Platform system that a client ride is starting.

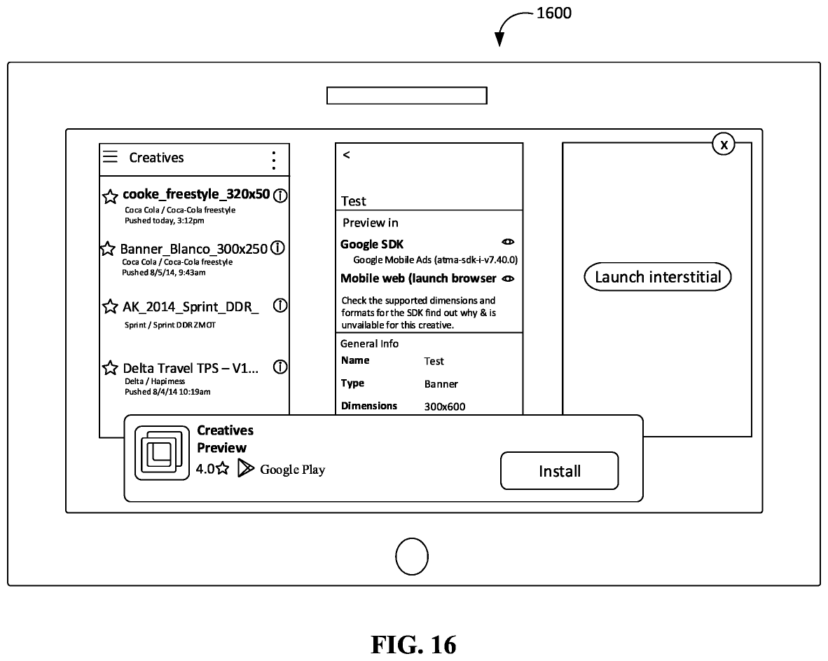

FIG. 16 is a schematic of an advertisement user interface 1600 of the VARA tablet, in accordance with some embodiments.

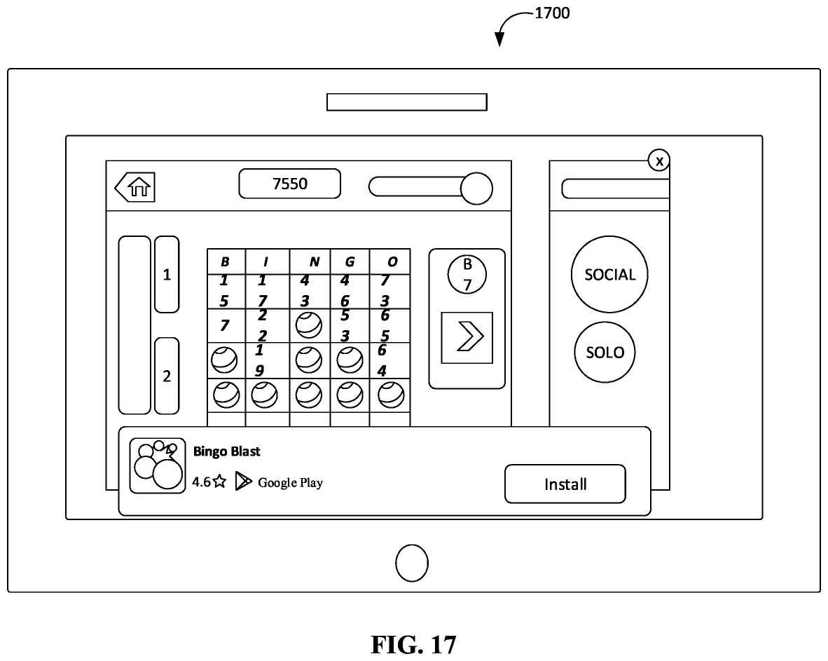

FIG. 17 is a schematic of a streaming advertisement user interface 1700 of the VARA tablet, in accordance with some embodiments.

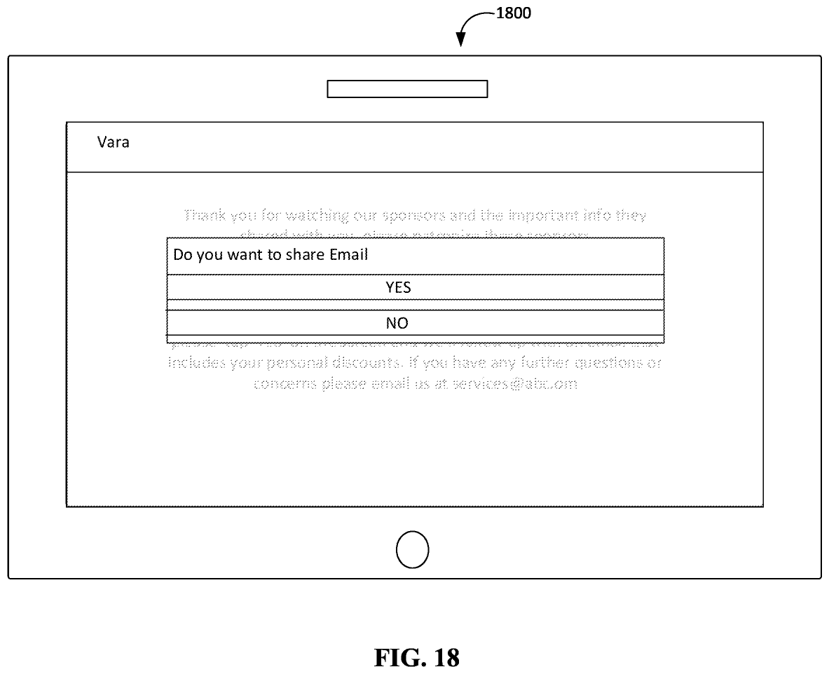

FIG. 18 is a schematic of a farewell user interface 1800 of the VARA tablet, in accordance with some embodiments. The farewell user interface 1800 is shown to the user on completion of the ride.

Further, the triggers for the farewell page are as follows:
Service partner application will send a trigger event to the VARA Platform system that a client ride has concluded (user has arrived at destination).
The screen will ask a user if they want to share their email with the VARA Platform and do not wish to share their information
User taps their option on screen by hitting one of the buttons
Ride information and user options are captured from the ride. First, a. user's selection is captured (Yes or No). If Yes, the user's email address (provided by Partner application request event). Authorization flag set to true. If no, email identified as ‘not provided’. Authorization flag set to false (initial state). Further, the ride information is captured including date and time, and how many adds were played (ride client identification (transaction no by Partner application)).

In accordance with some embodiments, the following steps may be performed in a vehicle daily routine for a VARA Platform Scenario (Vehicle Advertising Revenue Assistance).

First, the driver logs into their Partner system (Uber™/Lyft™/etc.) to prepare for their work shift.

Second, the driver also logs into the VARA platform and initializes the VARA Platform (the login user interface 1300)

Third, passenger screens wait at the home page user interface 1400 until a ride stars or the Platform is signed out.

Fourth, upon each ride the Platform will execute the following loop:
The Platform will initialize upon a wake-up transaction from the partner application.
The Platform will run through the welcome page(s)˜approx. 1 min. (the welcome user interface 1500)
The Platform will move to the ads page where the following will be displayed ads from Google's ad's service taking up ⅔ of the screen area and a GPS representation of the ride in progress.
The Platform will continue to cycle through appropriate ads (based on location and/or Google's, other add service companies or VARA's own ads algorithms) until the system receives a notice of ride destination/completion from the partner system. (the advertisement user interface 1600)
The platform will display a farewell page & message that will allow the passenger to consent or not to the Platform sending them coupons or additional opportunities for the ads that played for them during the ride. (the streaming advertisement user interface 1700)
The platform will record the ads and rider information into the cloud database collections.
The system will return to the waiting page (the home page user interface 1400)

Fifth, the driver or the system will sign-out upon a sign-out of the partner application trigger event if available, otherwise it will be done manually by the driver (the login user interface 1300).

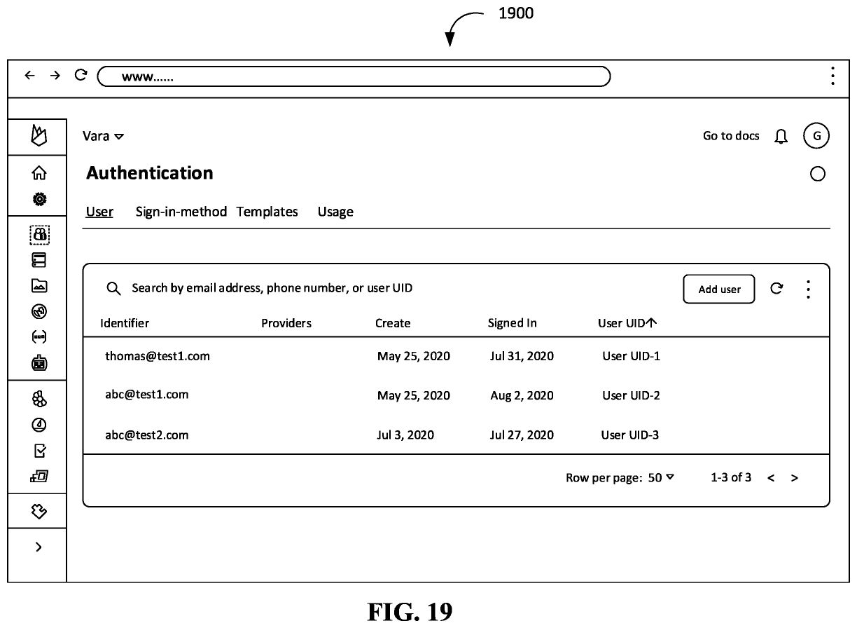

FIG. 19 is a schematic of an authentication user interface 1900 of a firebase or other database cloud admin, in accordance with some embodiments. The user log-in information may be stored in the firebase cloud.

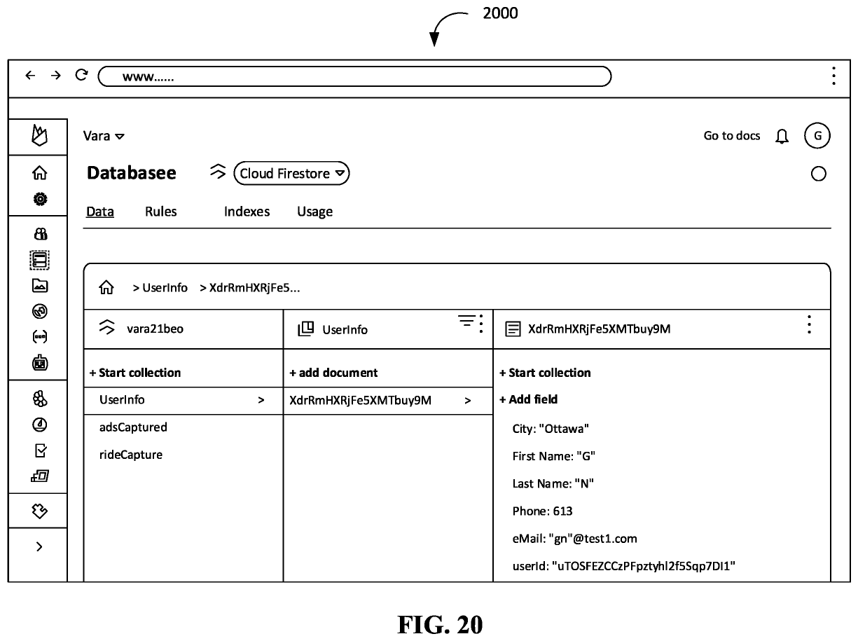

FIG. 20 is a schematic of a user information user interface 2000 of the firebase or other database cloud admin, in accordance with some embodiments. The user information may be stored in the firebase cloud. The user information may include one or more of:
1) City: Used to capture the city that the operator is working in for including localized targeted ads where applicable.
2) First Name: Driver's first name
3) Last Name: Driver's family name
4) Phone: Driver's phone number for text messages and as contact ID
5) eMail: Driver's email address for emailing and as contact ID
6) userID: The cross-reference to the driver's sign-in information on the system

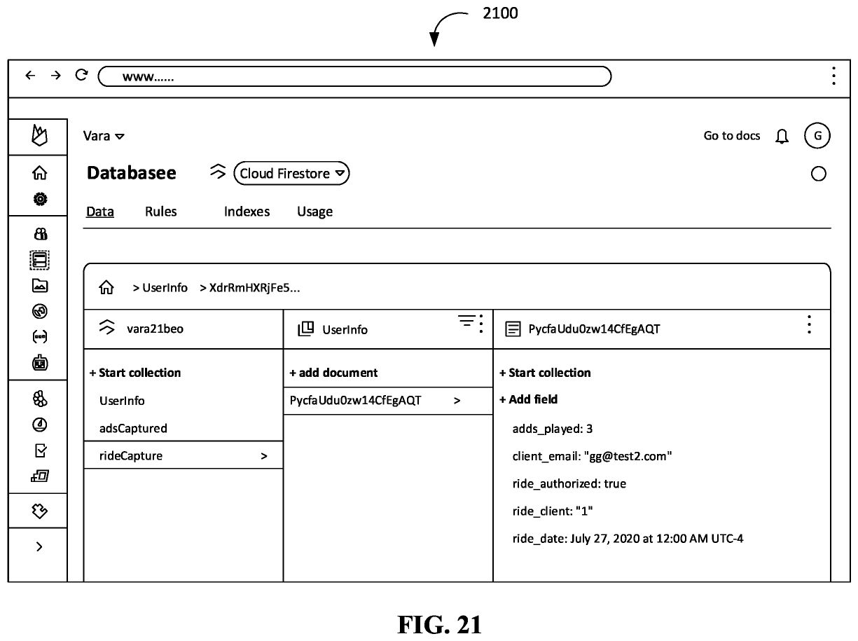

FIG. 21 is a schematic of a ride capture user interface 2100 of the firebase or other database cloud admin, in accordance with some embodiments.

The Ride Capture may include one or more following fields:
1) ads_played: Used to capture the number of ads played to the client during a recorded ride
2) client_email: Used to capture the client email upon client consent. This is to be provided by the partner application's API for the client being transported.
3) ride_authorized: Flag indicating the client has provided consent to send them material with their email address.
4) ride_client: Identification number of clients. This is to be provided by the partner application's API for the client being transported.
5) ride_date: The date and time that the ride and advertising were provided to the client.

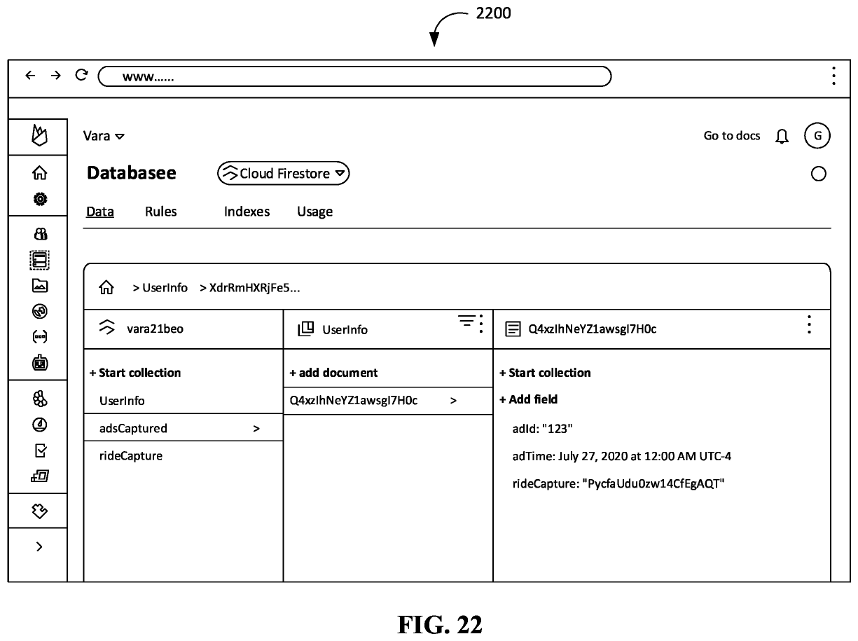

FIG. 22 is a schematic of ads captured user interface 2200 of the firebase cloud admin, in accordance with some embodiments. The ads captured may include one or more following fields:

1) adId: The id or way that the system identifies the add that played.

2) adTime: The date and time the ad was played to the rider. This will correlate to the ride_date in the rideCapture collection.

3) rideCapture: This is the document ID to which this adCapture information belongs. The number of adsCaptured documents with matching rideCapture ids should match up with the number recorded in ads_played within each rideCapture.

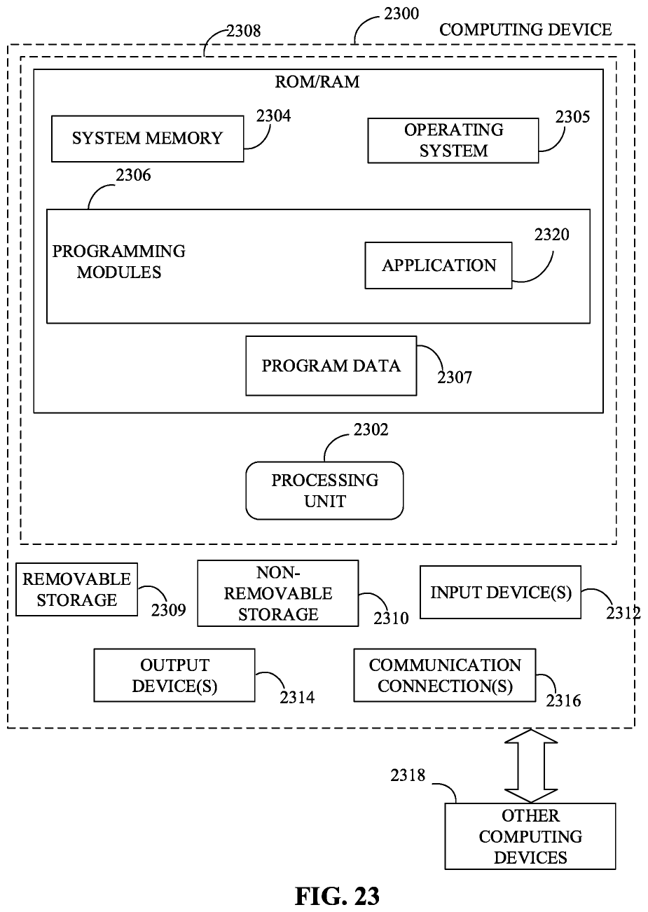

With reference to FIG. 23, a system consistent with an embodiment of the disclosure may include a computing device or cloud service, such as computing device 2300. In a basic configuration, computing device 2300 may include at least one processing unit 2302 and a system memory 2304. Depending on the configuration and type of computing device, system memory 2304 may comprise, but is not limited to, volatile (e.g. random-access memory (RAM)), non-volatile (e.g. read-only memory (ROM)), flash memory, or any combination. System memory 2304 may include operating system 2305, one or more programming modules 2306, and may include a program data 2307. Operating system 2305, for example, may be suitable for controlling computing device 2300's operation. In one embodiment, programming modules 2306 may include analyzing event data module, identifying promotional content module, generating tracking data module, generating revenue data module etc. Furthermore, embodiments of the disclosure may be practiced in conjunction with a graphics library, other operating systems, or any other application program and is not limited to any particular application or system. This basic configuration is illustrated in FIG. 23 by those components within a dashed line 2308.

Computing device 2300 may have additional features or functionality. For example, computing device 2300 may also include additional data storage devices (removable and/or non-removable) such as, for example, magnetic disks, optical disks, or tape. Such additional storage is illustrated in FIG. 23 by a removable storage 2309 and a non-removable storage 2310. Computer storage media may include volatile and non-volatile, removable and non-removable media implemented in any method or technology for storage of information, such as computer-readable instructions, data structures, program modules, or other data. System memory 2304, removable storage 2309, and non-removable storage 2310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2300. Any such computer storage media may be part of device 2300. Computing device 2300 may also have input device(s) 2312 such as a keyboard, a mouse, a pen, a sound input device, a touch input device, a location sensor, a camera, a biometric sensor, etc. Output device(s) 2314 such as a display, speakers, a printer, etc. may also be included. The aforementioned devices are examples and others may be used.

Computing device 2300 may also contain a communication connection 2316 that may allow device 2300 to communicate with other computing devices 2318, such as over a network in a distributed computing environment, for example, an intranet or the Internet. Communication connection 2316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2304, including operating system 2305. While executing on processing unit 2302, programming modules 2306 (e.g., application 2320 such as a VARA application) may perform processes including, for example, one or more stages of methods, algorithms, systems, applications, servers, databases as described above. The aforementioned process is an example, and processing unit 2302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM.

Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A system for facilitating presentation of promotional content to a user of a ride-sharing service, the system comprising:
a communication device configured for:
receiving an event data associated with a ride-sharing session, wherein the ride-sharing session is associated with each of a user account and a driver account, wherein the user account is associated with the user, wherein the driver account is associated with a vehicle operated by a driver during the ride-sharing session;
receiving a promotional content from a promotional content provider device; and
transmitting the promotional content to a vehicular presentation device comprised in the vehicle, wherein the vehicular presentation device is configured for presenting the promotional content;
a processing device communicatively coupled to the communication device, wherein the processing device is configured for:
analyzing the event data;
identifying the promotional content based on the analyzing;
generating a tracking data based on the transmitting of the promotional content to the vehicular presentation device, wherein the tracking data comprises a promotional content indicator associated with the promotional content and a driver account identifier associated with the driver account; and
generating a revenue data based on the tracking data; and
a storage device communicatively coupled to the processing device, wherein the storage device is configured for storing each of the tracking data and the revenue data in association with the driver account identifier.

2. The system of claim 1, wherein the event data is received from a ride-sharing server.

3. The system of claim 1, wherein the event data is received from a driver mobile device, wherein the driver mobile device is configured for capturing the event data from a ride sharing application executing on the driver mobile device and transmitting the event data.

4. The system of claim 1, wherein the event data comprises at least one of a start ride-sharing event, a stop ride-sharing event, an add-stop event and an in-progress ride sharing event.

5. The system of claim 1, wherein the communication device is further configured for receiving a current location data from at least one of the driver mobile device, an on-board navigation system comprised in the vehicle and the vehicular presentation device, wherein the identifying of the promotional content is based on the current location data.

6. The system of claim 1, wherein the communication device is further configured for:
transmitting a consent prompt to the vehicular presentation device based on the stop ride-sharing event, wherein the vehicular presentation device is configured for presenting the consent prompt to the user;
receiving a consent indicator from the vehicular presentation device, wherein the vehicular presentation device comprises an input device configured for receiving the consent indicator from the user;
transmitting a user information prompt to the vehicular presentation device, wherein the vehicular presentation device is configured for presenting the user information prompt to the user;
receiving user information associated with the user from the vehicular presentation device, wherein the input device is configured for receiving the user information from the user; and
transmitting the promotional content to a user mobile device associated with the user based on the user information, wherein the promotional content comprises a promotional offer.

7. The system of claim 1, wherein the promotional content comprises a plurality of promotional content items and a plurality of time periods associated with the plurality of promotional content items, wherein the tracking data comprises a number indicator associated with the plurality of promotional content items and a plurality of time indicators associated with the plurality of time periods.

8. The system of claim 1, wherein the processing device is configured for:
generating a time stamp associated with the transmitting of the promotional content, wherein the tracking data further comprises the time stamp associated with the promotional content;
analyzing the tracking data; and
generating an analytical report based on the analyzing of the tracking data, wherein the communication device is further configured for transmitting the analytical report and the revenue data to the driver mobile device.

9. The system of claim 1, wherein the promotional content provider device comprises an online advertisement platform, wherein the communication device is further configured for:
receiving ride information from a ride-sharing server associated with the ride-sharing session; and
transmitting at least one keyword to the online advertisement platform, wherein the receiving of the promotional content is in response to the transmitting of the at least one keyword, wherein the processing device is further configured for generating the at least one keyword based on the ride information.

10. The system of claim 1, wherein the communication device is further configured for receiving at least one of a plurality of location data and a motion data from at least one of the driver mobile device and the vehicular presentation device, wherein the processing device is further configured for determining a motion state of the vehicle based on at least one of the plurality of location data and the motion data, wherein the identifying of the promotional content is based on the motion state.

11. A method for facilitating presentation of promotional content to a user of a ride-sharing service, the method comprising:
receiving, using a communication device, an event data associated with a ride-sharing session, wherein the ride-sharing session is associated with each of a user account and a driver account, wherein the user account is associated with the user, wherein the driver account is associated with a vehicle operated by a driver during the ride-sharing session;
analyzing, using a processing device, the event data;
identifying, using the processing device, a promotional content based on the analyzing;
receiving, using the communication device, the promotional content from a promotional content provider device;
transmitting, using the communication device, the promotional content to a vehicular presentation device comprised in the vehicle, wherein the vehicular presentation device is configured for presenting the promotional content;
generating, using the processing device, a tracking data based on the transmitting of the promotional content to the vehicular presentation device, wherein the tracking data comprises a promotional content indicator associated with the promotional content and a driver account identifier associated with the driver account;
generating, using the processing device, a revenue data based on the tracking data; and
storing, using a storage device, each of the tracking data and the revenue data in association with the driver account identifier.

12. The method of claim 11, wherein the event data is received, using the communication device, from a ride-sharing server.

13. The method of claim 11, wherein the event data is received, using the communication device, from a driver mobile device, wherein the driver mobile device is configured for capturing the event data from a ride sharing application executing on the driver mobile device and transmitting the event data.

14. The method of claim 11, wherein the event data comprises at least one of a start ride-sharing event, a stop ride-sharing event, an add-stop event and an in-progress ride sharing event.

15. The method of claim 11 further comprising receiving, using a communication device, a current location data from at least one of the driver mobile device, an on-board navigation system comprised in the vehicle and the vehicular presentation device, wherein the identifying of the promotional content is based on the current location data.

16. The method of claim 11 further comprising:
transmitting, using the communication device, a consent prompt to the vehicular presentation device based on the stop ride-sharing event, wherein the vehicular presentation device is configured for presenting the consent prompt to the user;
receiving, using the communication device, a consent indicator from the vehicular presentation device, wherein the vehicular presentation device comprises an input device configured for receiving the consent indicator from the user;
transmitting, using the communication device, a user information prompt to the vehicular presentation device, wherein the vehicular presentation device is configured for presenting the user information prompt to the user;
receiving, using the communication device, user information associated with the user from the vehicular presentation device, wherein the input device is configured for receiving the user information from the user; and
transmitting, using the communication device, the promotional content to a user mobile device associated with the user based on the user information, wherein the promotional content comprises a promotional offer.

17. The method of claim 11, wherein the promotional content comprises a plurality of promotional content items and a plurality of time periods associated with the plurality of promotional content items, wherein the tracking data comprises a number indicator associated with the plurality of promotional content items and a plurality of time indicators associated with the plurality of time periods.

18. The method of claim 11, further comprising:
generating, using the processing device, a time stamp associated with the transmitting of the promotional content, wherein the tracking data further comprises the time stamp associated with the promotional content;
analyzing, using the processing device, the tracking data;
generating, using the processing device, an analytical report based on the analyzing of the tracking data; and
transmitting, using the communication device, the analytical report and the revenue data to the driver mobile device.

19. The method of claim 11, further comprising:
receiving, using the communication device, ride information from a ride-sharing server associated with the ride-sharing session;
generating, using the processing device, at least one keyword based on the ride information; and
transmitting, using the communication device, the at least one keyword to an online advertisement platform, wherein the receiving of the promotional content is in response to the transmitting of the at least one keyword, wherein the promotional content provider device comprises the online advertisement platform.

20. The method of claim 11, further comprising:
receiving, using the communication device, at least one of a plurality of location data and a motion data from at least one of the driver mobile device and the vehicular presentation device; and
determining, using the processing device, a motion state of the vehicle based on at least one of the plurality of location data and the motion data, wherein the identifying of the promotional content is based on the motion state.
